(19) United States
(12) Patent Application Publication
(10) Pub. No.: US 2026/0001309 A1
(43) Pub. Date: Jan. 1, 2026

(54) MESH SCREEN FRAME LAMINATOR HEATING AND GUIDE STRUCTURE

(71) Applicant: Erdman Automation Corporation, Princeton, MN (US)

(72) Inventors: Morgan W. Donohue, North Oaks, MN (US); Ryan Lloyd Henry Roberts, Isanti, MN (US); Dale J. Hatch, Milaca, MN (US); Evan Garrett, Henderson, NV (US); Andrew D. Peterson, Zimmerman, MN (US); Peter J. Kroll, Saint Stephen, MN (US)

(21) Appl. No.: 18/756,537

(22) Filed: Jun. 27, 2024

(51) Int. Cl. B32B 37/06; B32B 37/10; B32B 37/18

(52) U.S. Cl. CPC B32B 37/06; B32B 37/10; B32B 37/18; B32B 2305/18

(57) ABSTRACT

A mesh to flexible screen frame laminator heater roller structure including a first pair of selectively driven rollers which are shiftable between a raised position and a lowered position relative to a first table. At least one driven roller of the first pair of the first pair of selectively driven rollers is smooth and another of the driven rollers of the first pair of selectively driven rollers is textured to facilitate movement of the flexible screen frame.

### TECHNICAL FIELD

Embodiments of the invention relate generally to removable window and door screens. In particular, example embodiments of the invention relate to the manufacturing of removable window screens that include a flexible frame that is resilient and a flexible mesh material that is bonded to the flexible frame.

### BACKGROUND

Fenestrations exist in buildings to permit ingress and egress, entry of fresh air and light. Screens have been used in these openings for many years to permit the entry and exit of air while excluding insects, debris, leaves and other undesired materials. Currently screens generally include a mesh material supported by a frame that holds the mesh material taut and facilitates insertion of the screen into the frame of a fenestration. For the purposes of this application, the term fenestration refers to any opening in the outside envelope of a building structure including but not limited windows and doors.

In many modern window screens a fiberglass mesh is supported in a frame. Other mesh materials commonly include nylon, polyester, bronze, stainless steel, aluminum, copper, brass and galvanized steel. Meshes made of fiberglass, nylon and polyester are generally quite flexible, while meshes that are made of stainless steel, aluminum, copper, brass and galvanized steel are relatively less flexible.

Screen frames are commonly made of rigid materials such as extruded aluminum, wood, steel or polymers. Occasionally, screens are made without a perimeter frame. In this case the screens are stretched taut over an opening often by a roller under spring tension.

More recently, other screen frames are made of flexible materials with resilient qualities. For example, some flexible screen frames are made from resilient steel that is coated with a polymer material. In many cases, the screen mesh is fused to the flexible screen frame by the application of heat which renders the polymer material of the screen frame, the screen mesh or both at least partially molten during the manufacturing of the screen. When the polymer material returns to its non-molten state the screen mesh is fused and strongly bound to the screen frame.

Such flexible screens are typically inserted into rigid fenestration frames by distorting the flexible window screen, generally by pushing inwardly on parallel rectilinear sides of the flexible window screen and then inserting the flexible window screen into grooves that surround the rigid fenestration frame on an inside of the fenestration frame. Similarly, flexible screens are generally removed by distorting the screen frame which then permits taking the screen frame out of the grooves. To facilitate this, the flexible screen frame is generally resiliently biased outwardly toward an approximately rectangular shape.

Currently, manufacturing of flexible window screen frames and flexible window screens is largely done by manual processes that are labor-intensive. These processes tend to be inefficient and time-consuming. Thus, rapid production of flexible screen frames and screens is not available.

Flexible screen frames are formed from spring metal such as spring steel that is bent to the shape of the screen and so that terminal ends of the metal material abut one another. Generally, the abutting ends of the flexible screen frame are located away from corners of the frame but not at a center of a straight side of the screen frame. The spring material is coated with a polymer material such as polyvinylchloride (PVC) also referred to as vinyl. Other polymer material coatings are, of course, possible.

Flexible screen frames are formed of spring material so that they can be deformed inwardly, inserted into a window frame and then be held in place by the resilience of the flexible screen frame material springing outwardly. Deformation of the flexible screen frame is generally accomplished by pressing inwardly on two opposing straight sides of the screen frame.

The abutting terminal ends of the shaped frame are welded to each other to form a closed geometric shape most commonly a rectangle or a square. Resistance welding is commonly used.

To facilitate the welding of the abutting ends of the frame, the polymer coating material must first be removed from the metal core material. Failure to remove the polymer material interferes with establishing electrical contact with the metal core of the frame material necessary for electrical welding and may result in contamination of any weld that is performed with the coating material present. Contaminated welds are often of inferior quality and may not hold up to the flexing encountered during insertion and removal of the flexible screen frame from a window or door structure.

Following welding of the abutted metal core ends it is good practice to clean the area of the weld to remove weld flash or spatter and possibly to mitigate any mushrooming of the abutted ends that may occur during the welding process.

It is also desirable to apply a new polymer coating over the stripped and welded area of the frame to mitigate corrosion and to facilitate adhesion of screen mesh in the area surrounding the weld. This is commonly accomplished by slipping a portion of heat shrink tube over the frame material prior to welding to join the abutting ends and moving the heat shrink material away from the portion to be welded until it is welded, cleaned and cooled. After the welding is performed, post weld cleaned and cooled the heat shrink tube is located to cover the previously stripped and welded portion and heat is applied to shrink it. The level of heat required to shrink the heat shrink tube is considerably less than that related to welding.

Fusing of screen mesh material to flexible screen frame material requires the application of heat and pressure to the materials to create a plastic welded permanent fusion between the screen mesh material and the flexible screen frame material. This creates a durable and self-securing flexible framed window screen which is less prone to damage and easier to handle than more conventional screen frames.

These processes are typically manually performed.

Accordingly, there is still room for improvement in the manufacturing of flexible window screens.

### SUMMARY

Example embodiments of the invention improve on many of the above discussed deficiencies of the prior art.

According to an example embodiment, the mesh to flexible screen frame laminator generally includes an entry table, a processing table and an exit table.

The entry table includes a horizontal supporting surface and a linear fence against which a flexible screen frame can be aligned. According to an example embodiment the entry table further includes a shrink tube heater adjacent the linear fence. The shrink tube heater may be structured to retract below the horizontal supporting surface and also to extend above the horizontal supporting surface. The entry table is at an elevated height relative to the processing table and the exit table. According to an example embodiment, the entry table may define a cut out into which an operator may step to facilitate the handling of smaller flexible screen frames. The cut out may be located relatively closer to the junction between the entry table and the processing table.

The shrink tube heater generally includes structure defining a trough into which the shrink tube and flexible screen frame material are received. Within the trough are heating elements. The heat elements may include halogen light and heat sources, electrical resistance heaters or may include a source of heated air for example. The trough is sized and shaped to receive the screen frame material therein with a small amount of clearance.

The processing table generally includes two pairs of heater rollers. At least one of each pair of heater rollers is adjustably horizontally movable relative to the other of the pair of heater rollers to accommodate various sizes of flexible screen frames. Each of heater rollers is further structured to be shiftable between a raised position and a lowered position. In the lowered position, the heater rollers are arranged to pinch flexible screen frame material between and upper roller and a lower roller so that the flexible screen frame material can be driven forward by friction with the heater rollers. The heater rollers may be heated by, for example, hot air or by electrical resistance. According to another example embodiment, heated air is applied directly to the mesh and the frame to fuse the mesh material through the polymer coating of the screen frame material. Heater rollers are power driven to advance the screen frame from the entry table to the processing table during the heating and fusing process.

According to another example embodiment of the invention, the heater rollers include an upper roller and a lower roller wherein at least one of the upper roller and the lower roller is textured while the other of the upper roller and the lower roller is smooth, for example to facilitate movement of the screen frame and/or screen material. According to an embodiment, the upper roller is smooth, and the lower roller is textured.

According to another example embodiment, a heater roller assembly further includes tensioning rollers located to engage screen mesh material outside of a perimeter of the screen frame. An axis of rotation of the tensioning rollers is oriented at a nonzero angle to the axis of rotation of the upper heater rollers, the lower heater rollers, or both. According to a further example embodiment, the tensioning rollers are adjustable to vary the axis of rotation of the tensioning rollers. For example, one end of the axle supporting the tensioning rollers may be rotatable about a vertically oriented axis while the other end of the axle can be secured in multiple angular positions for example by a fastener. In a further example, multiple predefine locations (e.g., screw holes) may be present to selectively secure the axle in one of several positions (e.g., using a fastener).

According to a further example embodiment, the tensioning rollers may include multiple rollers secured in parallel and adjacent one another on an axle (e.g., a common axle).

In another example embodiment, heat is applied to the flexible screen frame simultaneously with initiation of movement by the upper and lower rollers.

The processing table also includes a cradle that is automatically shiftable between a raised position and a lowered position. According to one example embodiment, the raised position of the cradle is generally coplanar with the entry table while the lowered position is generally coplanar with the processing table and the exit table. According to another example embodiment, the cradle is generally coplanar with the entry table in the raised position and is tilted downwardly in the lowered position to permit a flexible screen frame to descend to the level of the processing table and the exit table. According to an example embodiment, the cradle is also shiftable in size along with the pair of heater rollers that is adjacent to the entry table to receive a window frame as it is moved from the entry table to the raised cradle. For the purposes of this application the terms generally coplanar or substantially coplanar mean that the two surfaces or tables are equal in height or coplanar within plus or minus 2.5 centimeters (1 inch.).

The exit table is adjacent to and is of approximately equal height to the processing table. A second pair of driven heater rollers is located proximate a juncture between the processing table and the exit table. These are similar in structure to the first pair of driven heater rollers and are oriented at approximately a 90° angle to the first pair of driven heater rollers. For the purposes of this application, angles that are referred to as approximately, substantially or generally at a particular angle are considered to be at that angle with a tolerance of plus or minus ten degrees. The second pair of driven heater rollers are adjustable as to separation and relative position. The second pair of driven heater rollers are shiftable between a raised position and a lowered position. In the lowered position the second pair of driven heater rollers is arranged to pinch flexible screen frame material and overlying screen mesh to facilitate the fusion of the polymer coating of the flexible screen frame material and the screen mesh applied thereto.

Thus, the first pair of driven heater rollers fused two parallel sides of the flexible window screen frame with the mesh material and the second pair of driven heater rollers fused the other two parallel sides of the flexible window screen frame that are generally orthogonal to the first parallel sides to create complete fusion of a perimeter of the mesh material with the frame material.

Example embodiments of the invention also include several fences that can facilitate keeping the straight sides of the flexible screen frame material rectilinear during processing. These fences include a linear fence and a short fence associated with the entry table. The fences may also include a cradle fixed fence and a cradle movable fence associated with the cradle and a further processing table fixed fence and processing table movable fence associated with the processing table. The cradle fixed fence and a cradle movable fence may also be setback from the infeed fences. According to another example embodiment, both infeed fences are short, meaning that the fences have a length that it shorter than a side of a screen frame that is intended to be processed. These fences, in example embodiments, of the invention assist in maintaining sides of the flexible screen frame in a straight orientation. It is important for the sides of the screen frame to be maintained straight to allow the flexible screen that is produced to function properly.

In an embodiment, a heater roller system of a laminator for securing a screen material to a flexible screen frame comprises two or more heater roller assemblies. A (e.g., each) heater roller assembly can include a smooth roller and a textured roller that are selectively driven. A (e.g., each) roller is configured to shift between a raised position and a lowered position relative to a table. The lowered position can be associated with the heater roller assembly selectively engaging the screen material and/or flexible screen frame between the smooth roller and the textured roller. A first heater roller assembly (e.g., of the two or more heater roller assemblies) is oriented transversely to a second heater roller assembly.

In an embodiment, the smooth roller of each heater roller assembly is configured to engage a top surface of flexible screen frame when in the lowered position and the textured roller of each heater roller assembly is configured to engage a bottom surface of the flexible screen frame, for example to facilitate movement of the flexible screen frame when the smooth roller and/or the textured roller are driven.

In an embodiment, the heater roller system can further comprise tensioning rollers for example located outside a perimeter of the screen frame and structured to selectively tension the screen material between them. The axis of rotation of the tensioning rollers is oriented at a non-zero angle relative to an axis of rotation of the first heater roller assembly.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a mesh to flexible screen laminator according to an example embodiment;

FIG. 2 is a plan view of the mesh to flexible screen frame laminator as depicted in FIG. 1;

FIG. 3 is a detail perspective view of a shrink tube heater in a raised position according to an example embodiment;

FIG. 4 is an elevational view of a cradle in a raised orientation according to an example embodiment;

FIG. 5 is a perspective view of the cradle of FIG. 3 in a lowered orientation;

FIG. 6 is a perspective view of a driven heater roller in a raised orientation according to an example embodiment;

FIG. 7 is a perspective view of the driven heater roller of FIG. 6 in a lowered orientation;

FIG. 8 is a further plan view of the mesh to flexible screen frame laminator as depicted in FIG. 1;

FIG. 9 is a plan view of a driven heater roller assembly according to an alternative example embodiment of the invention;

FIG. 10 is a side elevational view of the driven heater roller assembly of FIG. 9;

FIG. 11 is a detailed sectional view, taken along section line A-A of FIG. 10, of a tapered roller according to an example embodiment;

FIG. 12 is a perspective view of a first end of a heater roller assembly according to an example embodiment;

FIG. 13 is a perspective view of a second, opposing end of the heater roller assembly depicted in FIG. 12;

FIG. 14 is a perspective view of a heater roller assembly according to an example embodiment; and

FIG. 15 is a perspective view of the heat roller assembly depicted in FIG. 14.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

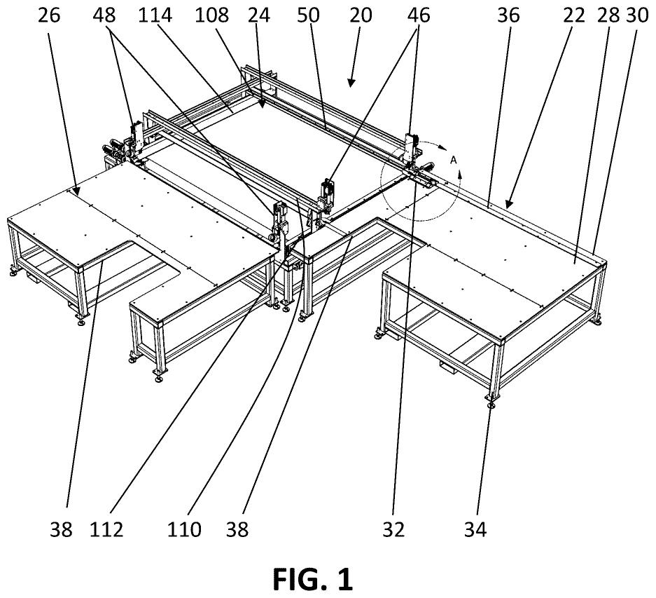

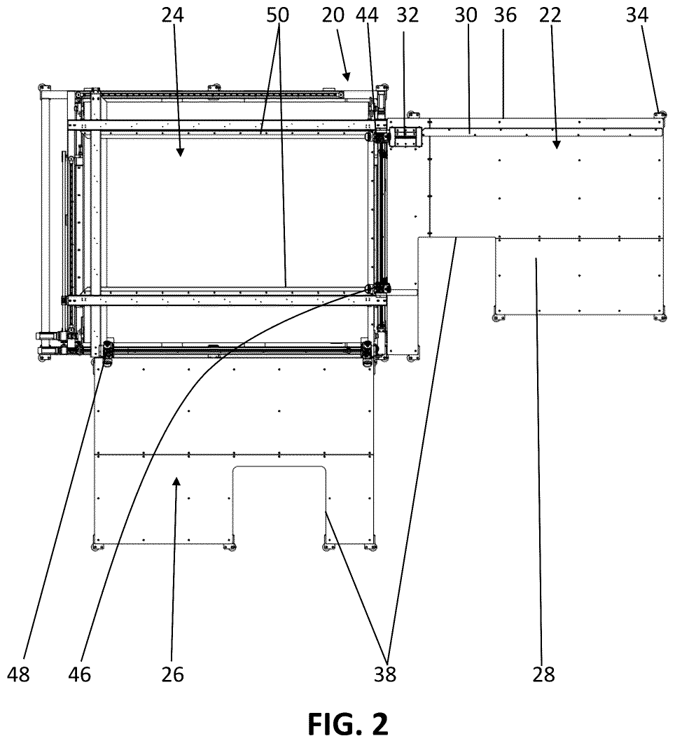

Referring particularly to FIGS. 1 and 2, according to an example embodiment, mesh to flexible screen frame laminator 20 generally includes entry table 22, processing table 24 and exit table 26.

Entry table 22 generally includes horizontal supporting surface 28, linear fence 30 and shrink tube heater 32. Horizontal supporting surface 28 is supported by floor engaging legs 34. Linear fence 30 is oriented parallel to perimeter edge 36 of horizontal supporting surface 28.

Shrink tube heater 32 is located adjacent, proximal to and parallel or co-linear with linear fence 30. Horizontal supporting surface 28 of entry table 22 is at an elevated height relative to processing table 24 and exit table 26. According to an example embodiment, entry table 22 may define cut out 38.

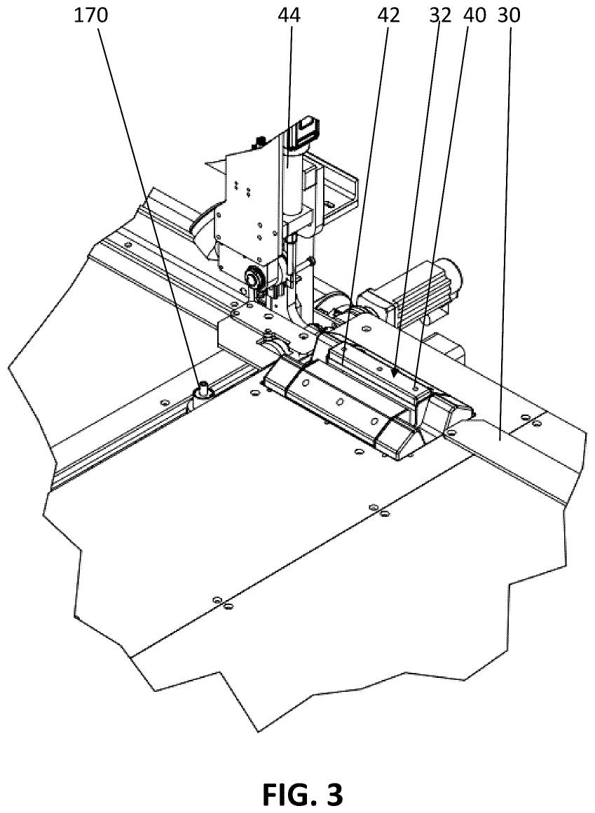

Referring particularly to FIG. 3, shrink tube heater 32 generally includes heater jaws 40 defining heater trough 42. Trough 42 is appropriately sized to receive screen frame material along with a surrounding shrink tube therein with a small amount of clearance. Shrink tube heater 32 is movable to be extended above horizontal supporting surface 28 and retracted below horizontal supporting surface 28. Shrink tube heater 32 is thus shiftable between an extended position above horizontal supporting surface 28 and a retracted position below horizontal supporting service 28. Shrink tube heater 32 includes halogen lamps (not shown) that emit primarily infrared light to heat shrink tube according to an example embodiment.

Processing table 24 is adjacent to entry table 22 and is lower than entry table 22. Processing table 24 generally includes two pairs of heater rollers 44. First pair of heater rollers 46 is located proximate entry table 22. Second pair of heater rollers 48 is located proximate exit table 26. First pair of heater rollers 46 is oriented at substantially a right angle to second pair of heater rollers 48. First pair of heater rollers 46 may be coupled to processing table 24 or entry table 22 or may be coupled to both tables. First pair of heater rollers 46 is located proximate the juncture between entry table 22 and processing table 24.

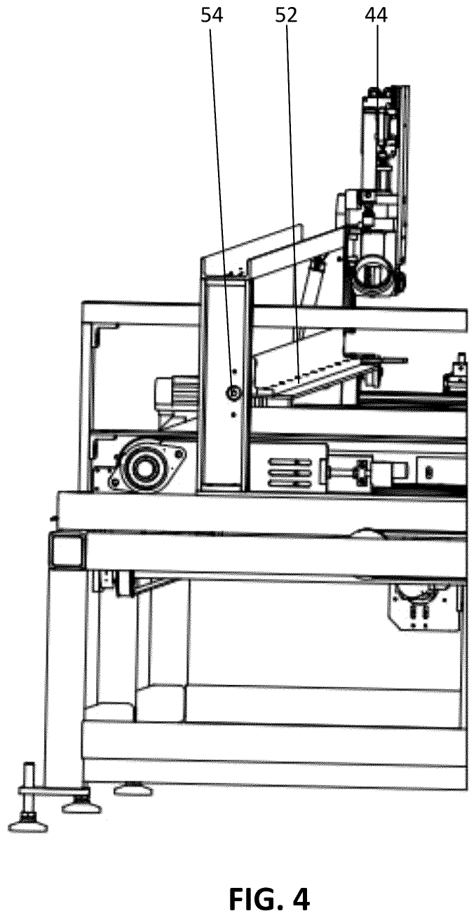

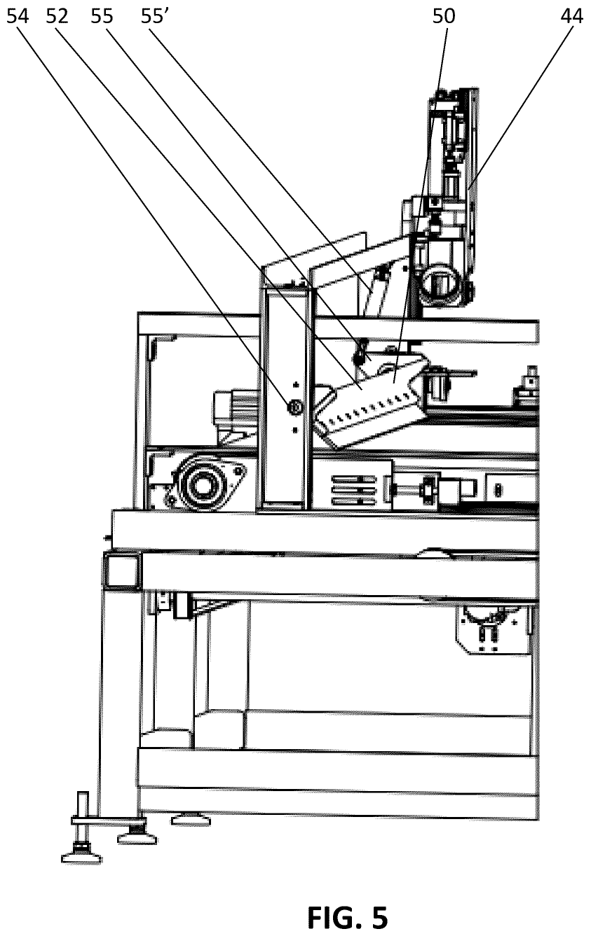

Processing table 24 further includes cradle 50. Cradle 50 is shiftable between a raised position and a lowered position as is depicted in FIGS. 4 and 5. In the depicted example embodiment cradle 50 further includes rotatable angle supports 52 which are rotatable about axle bearings 54. Rotatable angle support 52 further includes bell crank 55 coupled to linear actuator 55′ as best seen in FIG. 5. Rotatable angle supports 52 are movably coupled to first pair of heater rollers 46 so that rotatable angle supports 52 are adjustable in width position along with first pair of heater rollers 46. Thus, rotatable angle supports 52 are each always aligned with one of first pair of heater rollers 46.

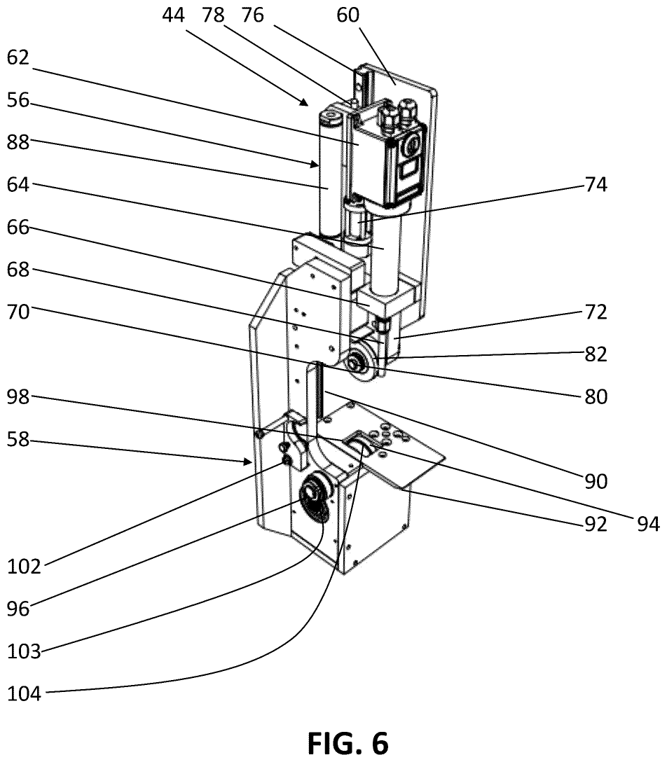

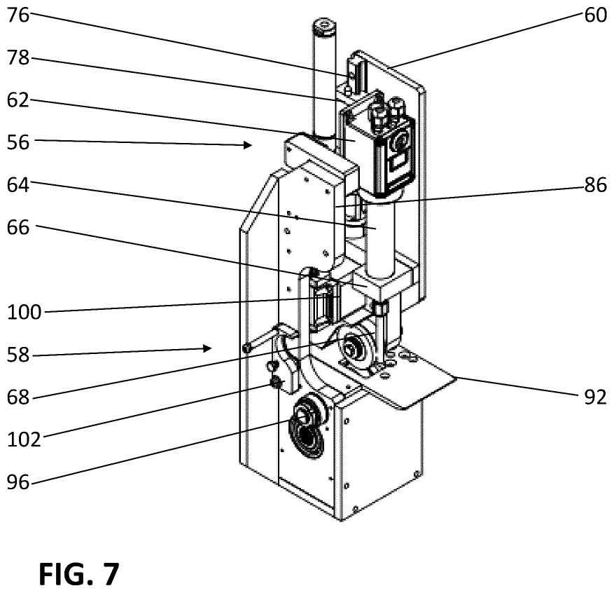

Referring now particularly to FIG. 6 and FIG. 7, an example heater roller 44 is depicted in a raised orientation and in a lowered orientation. Heater roller 44 generally includes upper portion 56 and lower portion 58. Upper portion 56 is movable relative to fixed lower portion 58.

Upper portion 56 generally includes upper support plate 60, control unit 62, heater tube 64, heater manifold 66, heater nozzle 68, roller wheel 70, roller wheel support 72, heater tube actuator 74, heater track 76 and heater traveler 78.

Control unit 62 is coupled to heater tube 64 which in turn is coupled separably to heater manifold 66. Heater manifold 66 encloses heating elements (not shown). Heater nozzle 68 extends downwardly from heater manifold 66 and terminates in close proximity to roller wheel 70. Heater tube 64 is shiftable between a coupled position relative to heater manifold 66 and an uncoupled position by the operation of heater tube actuator 74. In the uncoupled position heater tube 64 is separated from heater manifold 66 so that heated air from heater tube 64 disperses into the ambient atmosphere. In the coupled position, heater tube 64 is in contact and fluid communication with heater manifold 66 so that heated air passes through heater manifold 66 which in turn is in fluid communication with heater nozzle 68. Heater tube 64 along with control unit 62 are coupled to heater traveler 78 in this example embodiment. Heater traveler 78 is movable vertically along heater track 76 by operation of the heater to actuator 74. Heater manifold 66 is secured to upper support plate 60 as is heater track 76. Heater traveler 78 is movably coupled to heater track 76.

Roller wheel 70 is supported on axle 80 which is supported by roller wheel support 72. Roller wheel support 72 is coupled to upper support plate 60. Roller wheel 70 is freely rotatable on axle 80 and, in the depicted example embodiment, presents concave groove 82 which is shaped to conform to screen frame material that is to be processed. According to another example embodiment, roller wheel 70 may be tapered in construction.

Lower portion 58 of heater roller 44 generally includes housing 84, upper portion support member 86, vertical actuator 88, upper portion track 90, table plate 92, and lower roller wheel 94.

Housing 84 supports upper portion support member 86 and partially encloses lower roller wheel 94. Lower roller wheel 94 is driven and rotates on lower axle 96. Lower roller wheel 94 is driven by a motor, which is not visible as it is enclosed within housing 84. Lower roller wheel 94 can be concavely grooved according to one example embodiment. Lower roller 94 may also be tapered in construction. Tapered construction of lower roller 94 can be made to complement tapered construction of roller wheel 70 according to an example embodiment of the invention. Either roller wheel 70 or lower roller 94 can be tapered in construction. It is not required that both rollers be tapered in construction. Nor is it required that both rollers be concave in construction.

Table plate 92 is structured to be positioned substantially coplanar with horizontal surface 28 of entry table 22. Table plate 92 presents wheel opening 98 which is sized and shaped to receive lower roller wheel 94 at least partially therethrough. Table plate 92 further partially forms housing 84. Upper portion track 90, most readily visible in FIG. 6, is structured to receive upper portion traveler 100 in slidable relation thereto. Upper portion traveler 100 is most readily visible in FIG. 7. Vertical actuator 88 is operably coupled to upper portion 56 and shifts upper portion 56 between a raised position as depicted in FIG. 6 and a lowered position as depicted in FIG. 7.

Lower roller wheel groove adjuster 102 and axle collar 104 are present on the exterior of housing 84. Lower roller wheel groove adjuster 102 is shiftable between an upright position as depicted and a lowered position in operable interaction with axle collar 103. Interaction of lower roller wheel groove adjuster 102 causes variation in the width of lower roller wheel groove 104.

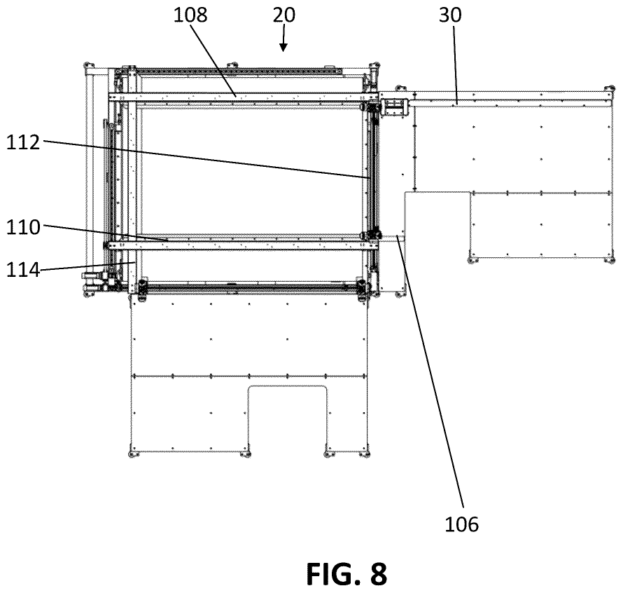

Referring particularly to FIG. 8, a plan view of mesh to screen frame laminator is shown. In addition to linear fence 30, mesh to screen frame laminator 20 further includes short fence 106, cradle fixed fence 108, cradle movable fence 110, processing table fixed fence 112 and processing table movable fence 114. Short fence 106 extends outwardly away from one of first pair of heater rollers 46 that is remotely located from linear fence 30 and parallel to linear fence 30. Cradle fixed fence 108 is located above processing table 24 and extends generally colinearly with linear fence 30. Cradle movable fence 110 is located on cradle 50 and extends colinearly with short fence 106 and parallel to cradle fixed fence 108. Processing table fixed fence 112 is substantially perpendicular to linear fence 30 and is located proximate entry table 22 on processing table 24. Processing table movable fence 114 is oriented substantially parallel to processing table fixed fence 112 and movable with one of second pair of heater rollers 48.

Referring again to FIG. 3, according to an example embodiment, movable, retractable alignment pegs 170 may be located at the juncture between entry table 22 and processing table 24 and at the juncture between processing table 24 and exit table 26. Alignment pegs 170 are vertically extendable and retractable so as to extend above horizontal supporting surface 28 when extended. Alignment pegs 170 may also be extendable and retractable so ask to extend above and retract below surfaces of processing table 24 and exit table 26. Alignment pegs 170 may be horizontally movable to move a partially finished or finished flexible screen frame with mesh to a next table (e.g., a subsequent station). Alignment pegs 170 may act as a stop for positioning of flexible screen frames.

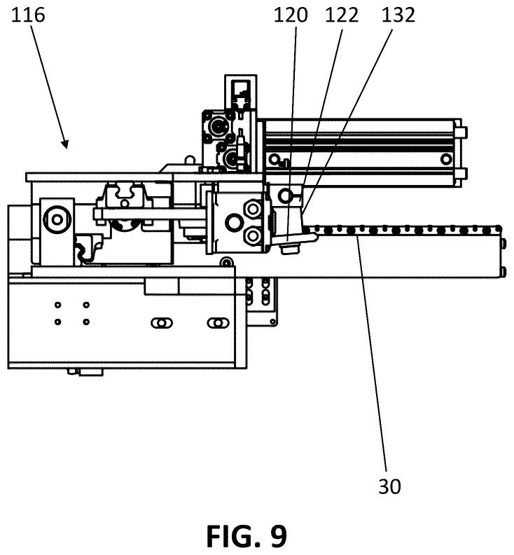

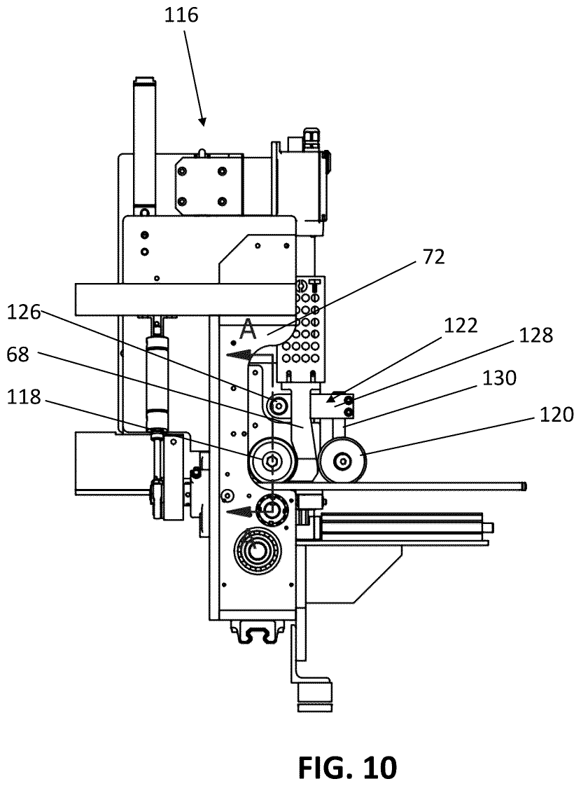

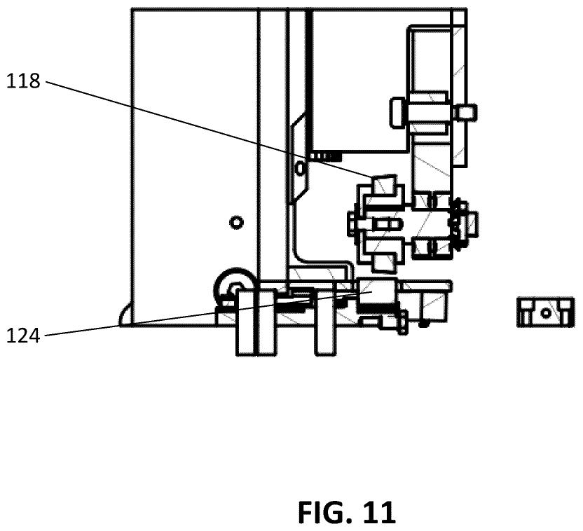

FIGS. 9, 10 and 11 depict heater roller assembly 116 according to an example embodiment (e.g., an example alternative of the structure of heater roller assembly 44). Referring particularly to FIGS. 9 and 10, tapered heater roller assembly 116, in addition to structures previously described, includes tapered roller 118, angled roller 120, angled roller carriage 122, and flat lower roller 124. Tapered roller 118 (e.g., as seen in FIG. 11) is tapered in a direction toward linear fence 30. Tapered roller 118 is generally aligned with flat lower roller 124. With continued reference to FIG. 9, angled roller 120 is supported by angled roller carriage 122 which is in turn supported by roller wheel support 72. Angled roller carriage 122 further includes axle 126, horizontal supporting member 128, vertical supporting member 130, and angled roller support 132.

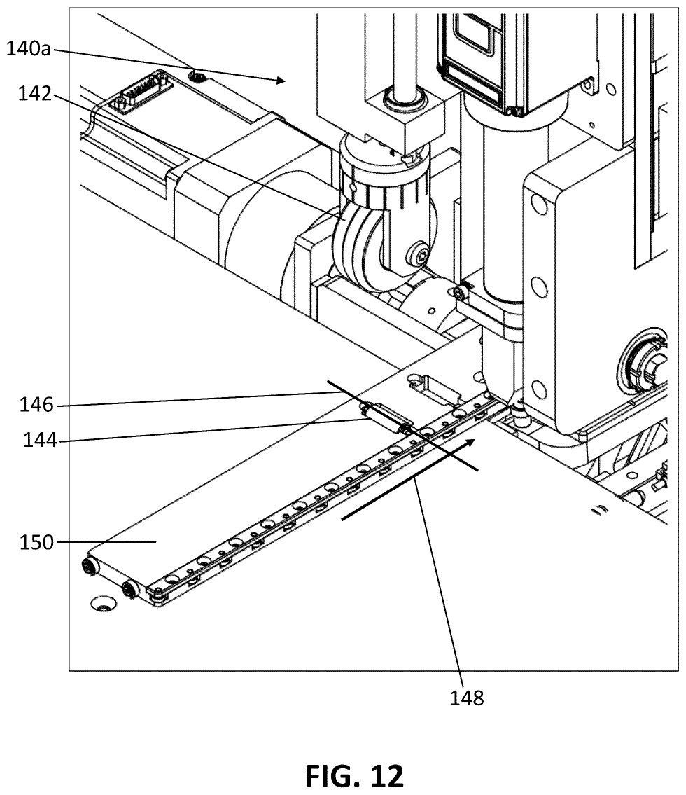

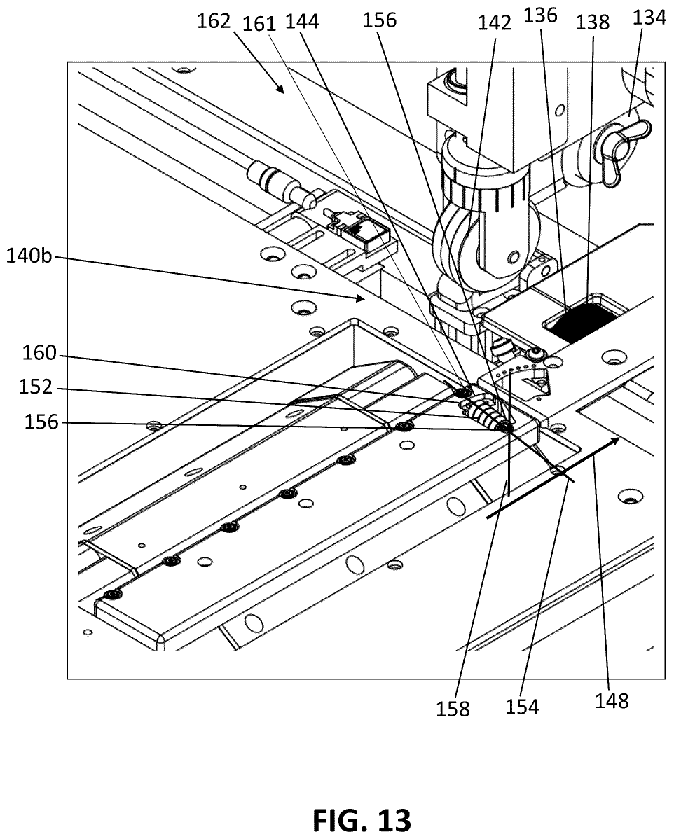

FIG. 12 depicts a tensioning roller assembly 140a according to an example embodiment. Tensioning roller assembly 140a is configured to receive screen mesh material, for example such that a screen frame being moved by upper drive roller 134 and lower drive roller 136 (e.g., adjacent to tensioning roller assembly 140b as shown in FIG. 13) would not be received by tensioning roller assembly 140a. Tensioning roller assemblies 140a and 140b are configured to engage screen mesh material without contacting screen frame material. Tensioning roller assembly 140a comprises upper tensioning roller 142 and lower tensioning roller 144, for example in an opposing orientation relative to one another. In examples, upper tensioning roller 142 and/or lower tensioning roller 144 may comprise one or more rollers or roller bearings (e.g., on a common axle).

Lower tensioning roller 144 is rotatable about axis 146 that is oriented at an orthogonal or non-orthogonal angle to direction of travel 148 of screen frame material. As can be seen in FIG. 12, axis 146 can be perpendicular to and offset from guide fence 150. Upper tensioning roller 142 is positioned and configured for downward movement, for example, towards lower tensioning roller 144. Upper tensioning roller 142 is shiftable between a raised orientation as depicted in FIGS. 12 and 13 disengaged from lower tensioning roller 144 and a lowered orientation with screen mesh material pinched between upper tensioning roller 142 and lower tensioning roller 144. During operation, upper tensioning roller 142 can, when lowered, bear down on screen mesh material (e.g., excess screen mesh material extending outside of the screen frame) located between upper tensioning roller 142 and lower tensioning roller 144. In examples, lower tensioning roller 144 may be oriented on axis 146 such that axis 146 is not adjustable. Lower tensioning roller 144 tends to resist tension placed on screen mesh material when upper tensioning roller 142 is lowered.

In examples, lower tensioning roller 144 can be angled to tension screen mesh material as it passes. The angle of lower tensioning roller 144 can be adjustable, for example to vary tension.

In examples, upper tensioning roller 142 and/or lower tensioning roller 144 can be knurled and/or textured to facilitate gripping screen frame materials.

Referring particularly to FIG. 13, heater roller assembly 162 comprising tensioning roller assembly 140b, upper drive roller 136, and lower drive roller 138 is depicted, according to an example embodiment. Heater roller assembly 162 can include driven rollers configured to receive a screen frame, for example upper drive roller 134 and lower drive roller 136. In examples, at least one of upper drive roller 134 and lower drive roller 136 is textured while the other of the upper drive roller 134 and the lower drive roller 136 is smooth. For example, as shown in FIG. 13 upper drive roller 134 is smooth and lower drive roller 136 is textured with textured surface 138. Textured surface 138 facilitates movement of the screen frame (e.g., by providing increased friction/grip compared to a smooth surface). This has been found helpful in engaging a polymer coating of the screen frame material.

Heater roller assembly 162 includes tensioning roller assembly 140b. In an embodiment, tensioning roller assembly 140b can be configured to receive an opposite end portion of screen mesh material than tensioning roller 140a. Tensioning roller assembly 140b can comprise adjustable tensioning rollers 152 (e.g., as/in place of lower tensioning roller 142). Adjustable tensioning rollers 152 can be adjustable to vary a non-orthogonal angle of axis of rotation 154 of adjustable tensioning rollers 152. For example, first end 156 of an axle supporting adjustable tensioning rollers 152 may be rotatable about a vertically oriented axis 158 while second end 160 of the axle can be secured in multiple angular positions (e.g., by a fastener). In examples, apertures 161 may be configured to receive a screw that secures the axle supporting adjustable tensioning rollers 152 in one of several positions. In examples, adjustable tensioning rollers 152 can include multiple parallel rollers or roller bearings secured (e.g., adjacent to one another) on a common axle (e.g., as shown in FIG. 13). In examples, adjustable tensioning rollers 152 can comprise a single roller bearing.

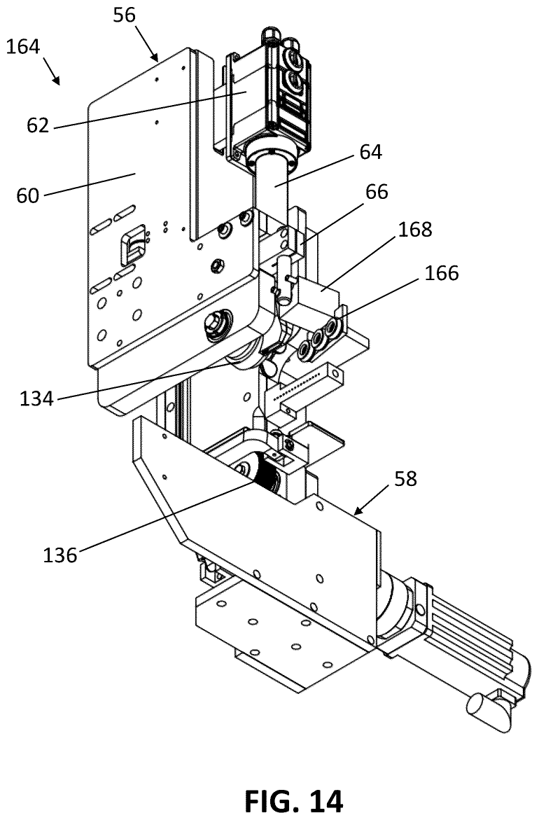

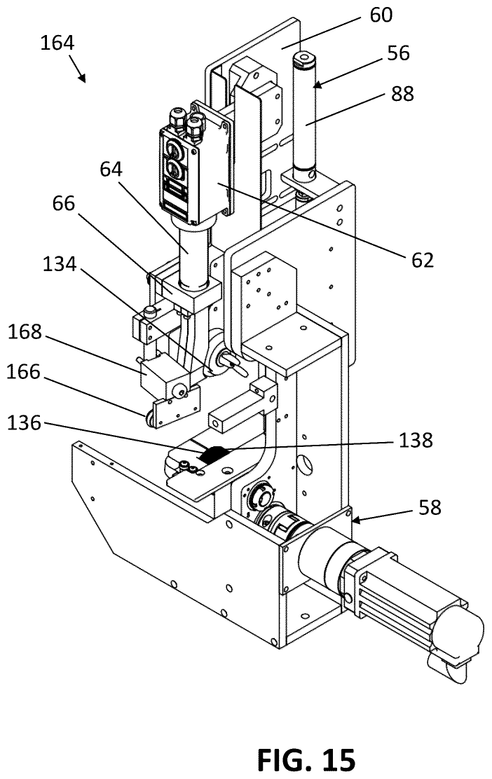

Referring to FIGS. 14-15, heater roller assembly 164 is depicted according to an example embodiment (e.g., an example alternative of the structure of heater roller assembly 162). Heater roller assembly 162 includes upper tensioning rollers 166 positioned in an upper configuration, for example, such that during operation screen mesh material passes below upper tensioning rollers 166 and between upper roller 134 and lower roller 136. Upper tensioning rollers 166 can be secured to upper portion 56 via attachment portion 168. For example, upper tensioning rollers 166 can be secured to heater manifold 66.

In an embodiment, upper tensioning rollers 166 are smooth rollers that are angled relative to the screen frame direction of advance and are present in serial order (e.g., such that upper tensioning rollers 166 assist in tensioning the screen frame mesh).

In an example embodiment, during operation heater manifold 66 moves into position prior to starting the motion of a frame (e.g., a frame being assembled). Heating is initiated by movement of the heater manifold 66, for example, at the start of the motion of the frame. For example, heat can be applied to a flexible screen of the frame via heater tube 64 (e.g., simultaneously) with initiation of movement by upper drive roller 134 and lower drive roller 136. In an embodiment, once heater manifold 66 is in position, the heater manifold 66 is stationary during movement of the frame (e.g., between upper drive roller 134 and lower drive roller 136).

Tensioning rollers (e.g., tensioning roller assembly 140a, 140b, upper tensioning rollers 166) can ensure consistent (e.g., even) tension of the mesh material across the flex frame. As the frame moves through a heater roller assembly, tensioning rollers can continuously facilitate maintenance of tension of the frame mesh and maintenance of tension facilitates even distribution of heat over and between the tensioned mesh and the screen frame material, mitigating hot spots or uneven heating by tending to prevent bunching. Such uniform heating facilitates achieving consistent properties and quality in the finished frame. Further, the use of tensioning roller assemblies 140a, 140b can minimize direct (e.g., manual) contact with the frames, reducing the risk of handling-related damage or deformation and ensuring that the frames maintain their integrity throughout the manufacturing process.

Moreover, textured drive roller (e.g., lower drive roller 136) can facilitate smooth movement of the flex frames through the heater assembly, reducing friction and resistance. Smoother operation can increase production efficiency by allowing frames to move through the heating process more quickly and with fewer interruptions. Increased production efficiency can enable less burning of the polymer—in addition to reducing cycle times and increasing throughput.

In an embodiment, heater pairs operate simultaneously on a single frame. In an embodiment, two frames can be in process at the same time, for example, such that four heads are operating simultaneously. In such an embodiment, two heater heads can operate as a pair.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. A heater roller system of a laminator for securing screen material to a flexible screen frame, the heater roller system comprising:
a first heater roller assembly comprising a first smooth roller and a first textured roller, wherein the first smooth roller and the first textured roller are selectively driven and at least one of the first smooth roller and the first textured roller is shiftable between a raised position and a lowered position relative to a first table; and
a second heater roller assembly comprising a second smooth roller and a second textured roller, wherein the second smooth roller and the second textured roller are selectively driven and at least one of the second smooth roller and the second textured roller is shiftable between a raised position and a lowered position relative to a second table; and
wherein the first heater roller assembly is oriented transversely to the second heater roller assembly.

2. The heater roller system of claim 1, further comprising a first tensioning roller and a second tensioning roller, wherein the first tensioning roller and the second tensioning roller are structured to selectively receive the screen material therebetween, wherein an axis of rotation of the second tensioning roller is oriented at a non-zero angle relative to an axis of rotation of the first heater roller assembly.

3. The heater roller system of claim 2, wherein the axis of rotation of the second tensioning roller is adjustable around an axis perpendicular to the axis of rotation of the second tensioning roller.

4. The heater roller system of claim 3, wherein the second tensioning roller is secured to an axle, and wherein adjusting the axis of rotation of the second tensioning roller comprises: positioning an end of the axle in one of a plurality of predefined locations.

5. The heater roller system of claim 2, wherein at least one of the first tensioning roller or the second tensioning roller comprises a plurality of rollers secured parallel and adjacent to one another on a respective axle.

6. The heater roller system of claim 1, wherein the first smooth roller is configured to engage a top surface of flexible screen frame when in the lowered position and the first textured roller is configured to engage a bottom surface of the flexible screen frame, wherein the first textured roller is textured to facilitate movement of the flexible screen frame when at least one of the first smooth roller or the first textured roller are driven.

7. The heater roller system of claim 6, further comprising a tensioning roller integrated into an alignment fence and positioned to abut a bottom surface of the screen material.

8. The heater roller system of claim 6, further comprising a tensioning roller secured to a heater manifold and positioned to abut a top surface of the screen material.

9. A method of laminating screen material to a flexible screen frame, comprising:
shifting a first heater roller assembly from a raised position to a lowered position relative to a first table, wherein the first heater roller assembly comprises a first smooth roller and a first textured roller that are selectively driven, wherein the first heater roller assembly is configured to selectively engage the flexible screen frame between the first smooth roller and the first textured roller in the lowered position;
moving the flexible screen frame via the first heater roller assembly, wherein the first textured roller is textured to facilitate movement of the flexible screen frame;
shifting the first heater roller assembly from the lowered position to the raised position; and
shifting a second heater roller assembly from the raised position to the lowered position relative to a second table, wherein the second heater roller assembly is oriented transversely to the first heater roller assembly and comprises a second smooth roller and a second textured roller that are selectively driven, wherein the second heater roller assembly is configured to selectively engage the flexible screen frame between the second smooth roller and the second textured roller in the lowered position.

10. The method of claim 9, further comprising receiving the screen material between a first tensioning roller and a second tensioning roller, wherein an axis of rotation of the second tensioning roller is oriented at a non-zero angle relative to an axis of rotation of the first heater roller assembly.

11. The method of claim 10, further comprising adjusting the axis of rotation of the second tensioning roller.

12. The method as claimed in claim 11, wherein the second tensioning roller is secured to an axle, and wherein adjusting the axis of rotation of the tensioning roller comprises: positioning an end of the axle in one of multiple predefined locations around an axis perpendicular to the axle.

13. The method as claimed in claim 10, wherein at least one of the first tensioning roller or the second tensioning roller comprises a plurality of rollers secured parallel and adjacent to one another on an axle.

14. The method as claimed in claim 9, wherein, when in the lowered position the first smooth roller is configured to engage a top surface of a flexible screen frame and the first textured roller is configured to engage a bottom surface of the flexible screen frame, wherein the first textured roller is textured to facilitate movement of the flexible screen frame when at least one of the first smooth roller or the first textured roller are driven.

15. The method of claim 14, further comprising engaging a bottom surface of the screen material with a tensioning roller integrated into an alignment fence.

16. The method of claim 14, further comprising engaging a top surface of the screen material with a tensioning roller secured to a heater manifold.

17. A method of welding a screen material to a flexible screen frame; comprising:
placing the flexible screen frame on a first table including a horizontal surface and an alignment fence, wherein the flexible screen frame abuts the alignment fence;
laying a portion of the screen material over the flexible screen frame; and
fusing the screen material to the flexible screen frame on two parallel sides by operation of a first pair of selectively driven heater rollers including a first roller that is smooth and a second roller that is textured while tensioning the screen material by engaging the screen material against tensioning rollers, wherein an axis of rotation of the tensioning rollers is oriented at a non-zero angle relative to an axis of rotation of at least one of the first roller and the second roller.

18. The method of claim 17, further comprising adjusting the axis of rotation of the tensioning rollers.

19. The method of claim 18, wherein the tensioning rollers are secured to an axle, and wherein adjusting the axis of rotation of the tensioning rollers comprises positioning an end of the axle in one of multiple predefined locations around an axis perpendicular to the axle.

20. The method of claim 17, wherein the tensioning rollers comprise a plurality of rollers secured parallel and adjacent to one another on an axle.
